(19) United States
(12) Patent Application Publication
(10) Pub. No.: US 2024/0429802 A1
(43) Pub. Date: Dec. 26, 2024

(54) Axial Flux Motor

(71) Applicant: CorePower Magnetics, Inc., Pittsburgh, PA (US)

(72) Inventors: Kevin Byerly, Pittsburgh, PA (US); Mark Nations, Raleigh, NC (US); Paul Ohodnicki, Allison Park, PA (US); Brett Riale, Allison Park, PA (US); Timothy Mould, Glenmont, OH (US)

(21) Appl. No.: 18/754,520

(22) Filed: Jun. 26, 2024

Related U.S. Application Data
(60) Provisional application No. 63/510,169, filed on Jun. 26, 2023.

(51) Int. Cl. H02K 21/24; H02K 1/14; H02K 1/2795; H02K 1/28; H02K 7/09; H02K 15/03

(52) U.S. Cl. CPC H02K 21/24; H02K 1/146; H02K 1/2795; H02K 1/28; H02K 7/09; H02K 15/03

(57) ABSTRACT

An axial flux motor with a modular design that can help to simplify manufacturing processes, The design also permits the use of various material types, such as mixed materials, rare earth containing, and rare earth free designs with high power density. The motor may include a rotor arranged in one or more rings and a stator arranged in one or more rings. The stator is positioned proximate to the rotor. The rotor, the stator, or both are formed of individual wedge segments to provide a modular design. The rotor and/or stator assemblies may include a structural bearing material mixed with magnetic materials.

### RELATED APPLICATIONS AND CLAIM OF PRIORITY

This patent document claims priority to U.S. Provisional Patent Application No. 63/510,169, filed Jun. 26, 2023, the disclosure of which is fully incorporated into this document by reference.

### BACKGROUND

This patent document relates generally to electric motors, and more specifically, to axial flux motors.

The manufacturing techniques currently utilized are difficult to automate and may result in quality defects of the core and motor construction.

This patent document describes a device that addresses at least some of the issues described above and/or other issues.

### BRIEF DESCRIPTION OF THE DRAWINGS

The drawings included in this document are for purpose of illustration, and are not intended to be limiting. Although many of the drawings include example dimensions, the dimensions shown in the drawing are merely examples; other dimensions are possible depending on the overall size and structure of the motor.

FIGS. 1A-1D illustrate various configurations of axial flux motors that may employ the segmented structures described in this document. This document may use the general term FIG. 1 to collectively refer to FIGS. 1A-1D.

FIGS. 2A-2C illustrate various views of a first embodiment of a rotor structure, while FIGS. 2D-2F illustrate various views of rotor segments that may be included in this embodiment. This document may use the general term FIG. 2 to collectively refer to FIGS. 2A-2D.

FIGS. 3A-3C illustrate various views of a second embodiment of a rotor structure.

FIGS. 3D-3F illustrate various views of rotor wedge segments that may be included in this embodiment. FIGS. 3G-3I illustrate various views of bridge segments that may be included in this embodiment. This document may use the general term FIG. 3 to collectively refer to FIGS. 3A-3I.

FIGS. 4A-4C illustrate various views of a third embodiment of a rotor. This document may use the general term FIG. 4 to collectively refer to FIGS. 4A-4C.

FIGS. 5A-5C illustrate various views of a fourth embodiment of a rotor. Rotor wedge segments for this embodiment are shown in the first side, perspective, and second side views of FIGS. 5D-5F. FIGS. 5G-5H show how the rotor wedge segments of this embodiment may be arranged in a ring. FIGS. 5I-L respectively provide top, side, perspective, and cross-sectional views of a carriage for holding the rotor wedge segments of this embodiment. This document may use the general term FIG. 5 to collectively refer to FIGS. 5A-5L.

FIGS. 6A-6C illustrate various views of a first embodiment of a stator. FIGS. 6D-6G illustrate various views of a first variation of a stator wedge segment for this embodiment, while FIGS. 6H-6K illustrate various views of a second variation of a stator wedge segment for this embodiment, FIGS. 6L-6N illustrate various views of a stator bridge segment for this embodiment. FIG. 6P illustrates an expanded view of a section of this stator, showing that the stator bridge segments are arranged in positions that alternate in polarity. This document may use the general term FIG. 6 to collectively refer to FIGS. 6A-6P.

FIG. 7 is a simplified diagram that illustrates how magnetomotive force may exist in configurations (such as that of FIG. 5) do not include a rotor back iron that supports the rotor segments.

FIGS. 8A and 8B illustrate example flux paths of prior axial flux motors, along with flux paths that may result from the embodiments described in this document.

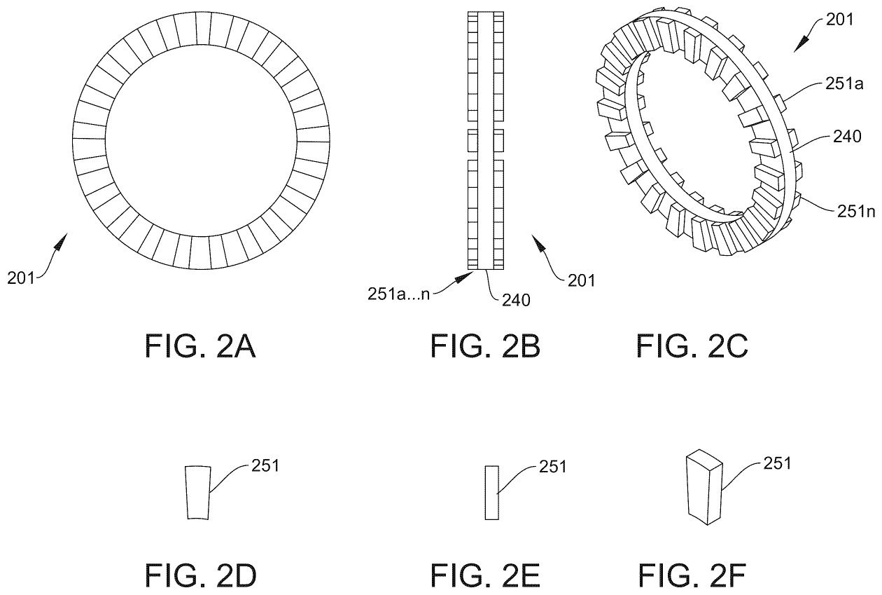

The figures of this document may use reference numbers for various components in which the reference numbers are followed by letter to indicate that the illustration shows multiple instances of that component. Unless needed to point to a specific one of the instances, the text below may simply use the number (without a following letter) to generally refer to any instance of the component. For example, the text below may generally use reference number 251 to refer to any of the elements 251a . . . 251n of FIG. 2.

### SUMMARY

In various embodiments, this document describes an axial flux motor with a modular design that can help to simplify manufacturing processes, The design also permits the use of various material types, such as mixed materials, rare earth containing, and rare earth free designs with high power density.

In some disclosed configurations, a segmented axial flux motor includes a rotor arranged in a first ring and a stator arranged in a second ring. The stator is positioned proximate to the rotor. The rotor, the stator, or both are formed of a plurality of individual wedge segments.

In some disclosed configurations, a segmented axial flux motor includes (a) a rotor assembly having a plurality of rotor segments; (b) a stator assembly having a plurality of stator segments; and (c) a structural bearing material mixed with magnetic materials within the rotor assembly or the stator assembly, wherein the rotor assembly and the stator assembly are configured in a modular design.

Methods of manufacturing a segmented axial flux motor are also disclosed. The methods may include: (a) fabricating a plurality of rotor segments; (b) fabricating a plurality of stator segments; and (c) assembling the rotor segments and stator segments to form a rotor assembly and a stator assembly, respectively, wherein (i) fabricating the rotor segments, fabricating the stator segments, or both comprises mixing a structural bearing material with magnetic materials for use within the rotor segments or the stator segments, and (ii) the rotor segments, the stator segments, or both comprise a plurality of material types.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun, such use is simply intended to distinguish one item from another, and is not intended to require a sequential order unless specifically stated. The terms “approximately” and “substantially,” when used in connection with a numeric value, is intended to include values that are close to, but not exactly, the number. For example, in some embodiments, the term “approximately” or “substantially” may include values that are within +/−1 percent, +/−5 percent, or +/−10 percent of the value. For example, the phrase “substantially equal” means, with respect to two values, values that are not more than 10%, 5% or 1% different from each other in various embodiments,

In this document, the term “connected”, when referring to two physical structures, means that the two physical structures touch each other. Devices that are connected may be secured to each other, or they may simply touch each other and not be secured.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

This disclosure is not limited to the particular systems, methodologies or protocols described, as these may vary. The terminology used in this description is for the purpose of describing the particular versions or embodiments only, and is not intended to limit the scope.

The following detailed description provides a more comprehensive understanding of the invention and its various embodiments, as well as the features and advantages thereof. It should be understood that the embodiments described herein are not limited to the specific examples provided but may be modified and adapted without departing from the scope of the invention.

In various embodiments, this disclosure describes a segmented axial flux motor with a modular design that simplifies manufacturing processes and enables the use of various material types. The motor comprises a rotor assembly having a plurality of rotor segments, a stator assembly having a plurality of stator segments, or both. In some embodiments, structural bearing materials are mixed with magnetic materials within the rotor assembly or stator assembly, providing mechanical stability and enhancing the electronic, magnetic, and mechanical performance of the motor.

The segmented design allows for the manufacturing of individual motor components using simpler processes, such as radial saw cutting, which are less time-consuming and generate less waste compared to more advanced machining techniques that may otherwise be required such as laser or water jet cutting methods. The modular design also supports the use of mixed materials, including bulk crystalline and nanocrystalline materials, as well as rare earth containing and rare earth free designs with high power density.

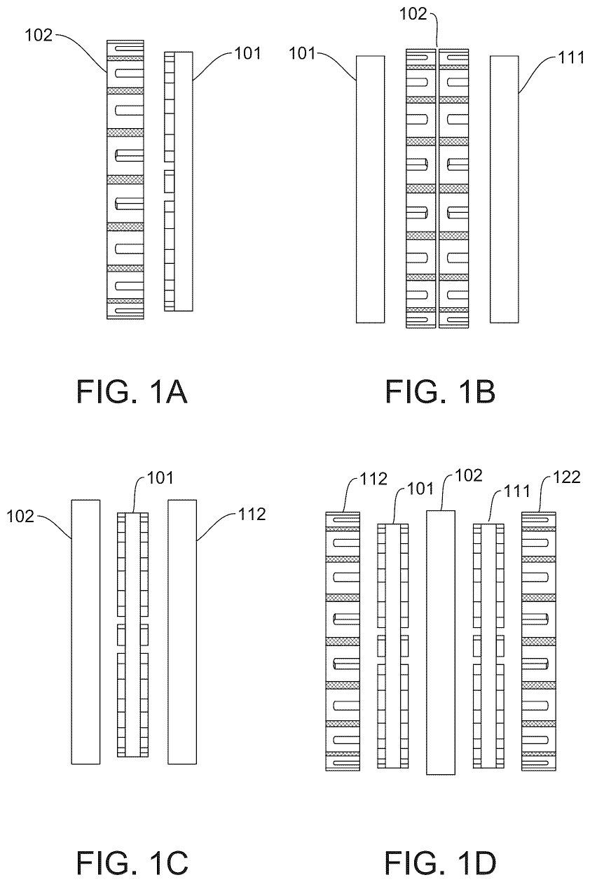

FIGS. 1A-1D illustrate various configurations of axial flux motors that may employ the segmented structures described in this document. FIG. 1A illustrates an embodiment with a single rotor 101 and a single stator 102. FIG. 1B illustrates an embodiment with two rotors 101, 111 and a single stator 102. FIG. 1C illustrates an embodiment with a single rotor 101 and two stators 102, 112. FIG. 1D illustrates an example multistage structure with multiple rotors 101, 111 and multiple stators 102, 112, 122. In each arrangement a rotor is positioned proximate to the stator so that an arrangement of magnets on the rotor provides force to the stator, and/or vice versa.

In various embodiments, the rotor(s), stator(s), or both the rotor(s) and stator(s) of the axial flux motors of this structure will employ one or more of the segmented structures described below. The segmented structures will employ segments that are fabricated (i.e., shaped) using die cutting, core winding, casting, forging, and/or additive manufacturing (such as 3D printing), or other methods that simplify the manufacturing process. The segments allow various motor configurations to be assembled from common (i.e., interchangeable) segment types. The segments will be secured to a base plate, to each other, or to an outer hub using an epoxy, as described below. Alternatively, the segments may be machined, formed, or otherwise attached to the base plate using other bonding methods, such as welding, brazing, or adhesive bonding.

Optionally, the segments may be manufactured without slot cutting or other complex 3D cuts, such as multi-axis waterjet cutting. Alternatively, the motor may be made using a process in which slot cutting is only employed in the separate, individual segments and not the base ring to which the segments are secured. Optionally, slot cutting may be employed on some segments or a full ring using through waterjet, abrasive cutting, milling, or electrical discharge machining, or another method.

In some embodiments, such as that shown in FIG. 1C, at least one rotor assembly 101 comprises a fully segmented rotor design, while at least one stator assembly 102, 112 may comprise a segmented or (as shown) monolithic stator. In this embodiment, even a “monolithic” stator may be partially segmented in that it may include individual permanent magnets attached to a monolithic structure. In other embodiments, such as that shown in FIG. 1B, at least one rotor assembly 101,111 comprises a monolithic rotor, and at least one stator assembly 102 comprises a fully segmented stator design.

FIGS. 2A-2C respectively illustrate a top view, a side view and a perspective view of a first embodiment of a rotor 201. FIGS. 2D-2F respectively illustrate a top view, a side view and a perspective view of a rotor wedge segment 251 that may be included in the first embodiment. The rotor 201 includes a base plate 240 formed as a ring, along with multiple rotor wedge segments 251 that are arranged on the base plate 240. The rotor wedge segments 251 may be arranged on each of the two opposite sides of the base plate 240 as shown, or the rotor wedge segments 251 may be arranged on only a single side of the base plate 240, depending on which of the motor configurations of FIG. 1 will employ the rotor 201.

The rotor wedge segments 251 shown in FIG. 2 are formed in the shape of wedges or teeth, with tapered sides so that the relatively larger top of each wedge is positioned along the outer perimeter of the base plate 240 and the relatively narrower bottom of each wedge is positioned along the inner edge of the base plate 240. FIGS. 2A and 2C illustrate that the rotor wedge segments 251 are spaced apart from each other substantially equally (i.e., substantially equidistant from each other) around the base. Tapered wedges may help to optimize the magnetic flux path and improve the motor's performance. Alternatively, the wedges can be formed with straight cuts (i.e., not tapered) to simplify cutting and integration into the base plate.

The rotor wedge segments 251 may be secured to the base plate 240 with an epoxy or by another bonding method such as those described above. In some cases, the rotor wedge segments may be installed within a housing, such as a carbon, glass, or other fiber housing or wrap, and mounted. Advantages of this approach may include relatively low windage losses and high mechanical strength given by the housing and the installed segmented rotor sections.

The rotor wedge segments 251 may be formed of a magnetic material to provide magnetic flux paths. Example materials may include nanocrystalline alloys (such as FeNiNbBSi, FeSiBNbCu, and/or an iron-nickel-cobalt alloy such as CoFeSiBNb, CoFeMnSiBNb, FeCoSiBNb, or FeCoSiBNbCu), amorphous alloys, electrical steels (such as FeSi), iron cobalt alloys, soft magnetic composites, soft magnetic ferrites, nitrides, and other such materials. The base plate 240 may be formed of a different one of the materials described above, or it may be formed of the same material as the rotor segments 251. Optionally, a corresponding permanent magnet (not shown) may be placed on top of each rotor wedge segment, or between each pair of rotor wedge segments, secured to the structure by an epoxy or other bonding material.

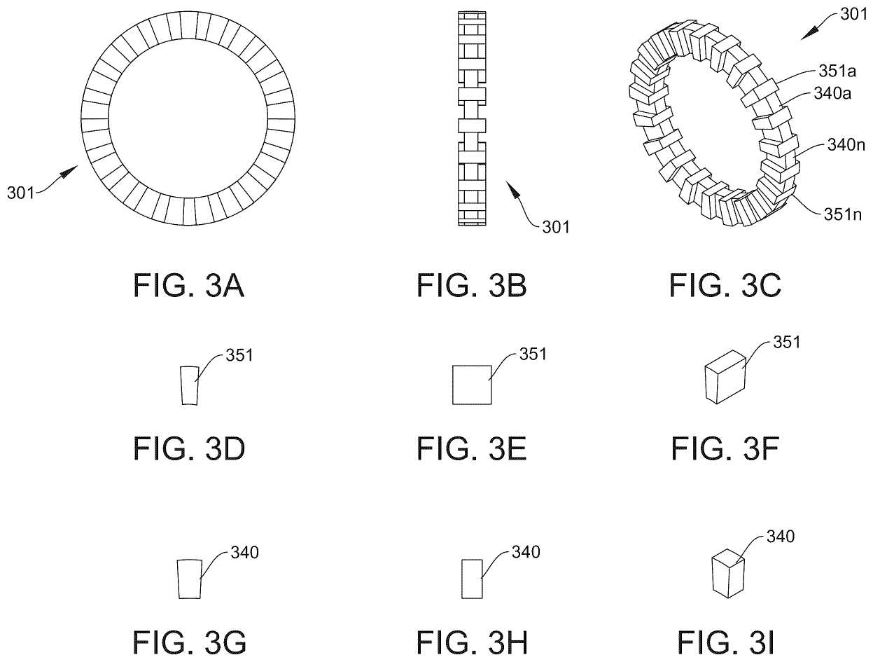

FIGS. 3A-3C respectively illustrate a top view, a side view and a perspective view of a second embodiment of a rotor 301. FIGS. 3D-3F respectively illustrate a top view, a side view and a perspective view of a rotor wedge segment 351 that may be included in this embodiment. Unlike the embodiment of FIG. 1, in FIG. 3 the rotor 301 includes no base plate but instead includes various bridge segments 340, each of which is attached to and thus interconnects and serves as a bridge between two rotor wedge segments 351. FIGS. 3G-3I respectively illustrate a top view, a side view and a perspective view of a bridge segment 340 that may be included in this embodiment.

The rotor wedge segments 351 shown in FIG. 3 are formed in the shape of wedges or teeth, with tapered first and second sides leading from a relatively wider top to a relatively narrower bottom. The first and second sides are wider than the third and fourth sides of the wedge. The top of each wedge is positioned along the outer perimeter of the rotor 301 and the relatively narrower bottom of each wedge are positioned to form an inner ring of the rotor 301. Alternatively, if the bridge segments 340 are sufficiently tapered, the wedges may not be tapered and instead may have straight sides so that the rotor wedge segments 351 exhibit the shape of a cuboid. The rotor wedge segments 351 will be formed of a magnetic material to provide magnetic flux paths. Example materials were described above in the discussion of the rotor segments 251 of FIG. 2.

The bridge segments 340 shown in FIG. 3 are formed in the shape of wedges or teeth, with tapered first and second sides leading from a relatively wider top to a relatively narrower bottom. The first and second sides are wider than the third and fourth sides of the wedge. The top of each wedge is positioned along the outer perimeter of the rotor 301 and the relatively narrower bottom of each wedge are positioned to form an inner ring of the rotor 301. Alternatively, if the wedge segments 351 are sufficiently tapered, the bridge segments 340 may not be tapered and instead may have straight sides so that the bridge segments 340 exhibit the shape of a cuboid. The bridge segments 340 will be formed of a material with different magnetic properties than the rotor wedge segments 351. Example materials for the bridge segments 340 were described above in the discussion of the base plate 240 in of FIG. 2.

The rotor wedge segments 351 are spaced apart from each other evenly (i.e., equidistant from each other) in a ring arrangement. Each rotor wedge segment 351 is positioned between and connected to two bridge segments 340 so that the rotor wedge segments 351 and bridge segments 340 alternate with each other to form a ring.

The rotor wedge segments 351 and bridge segments 340 may be secured to each other with an epoxy or by another bonding method such as those described above.

Optionally, a corresponding permanent magnet (not shown) may be placed on top of each rotor wedge segment, or between each pair of rotor wedge segments, secured to the structure by an epoxy or other bonding material.

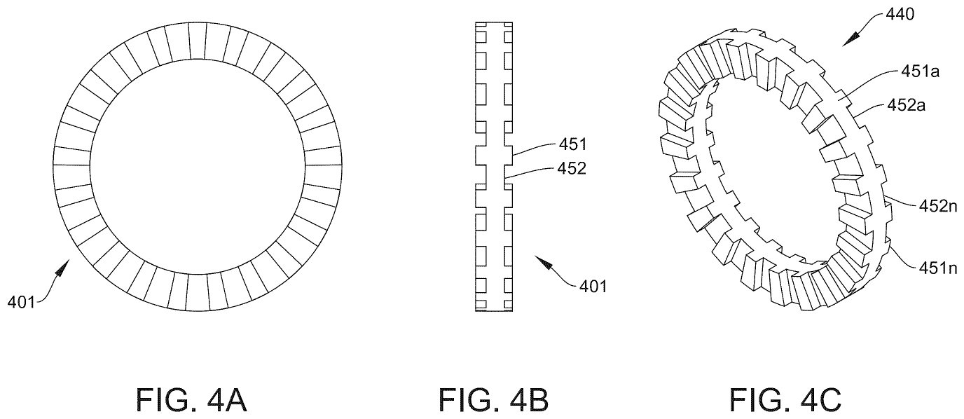

FIGS. 4A-4C respectively illustrate a top view, a side view and a perspective view of a third embodiment of a rotor 401. In FIG. 4 the rotor 401 is formed from a core 440 that is in the shape of a ring and made of a magnetic material such as those described in previous embodiments. In this embodiment, a set of evenly spaced and sized channels 452a . . . 452n are formed in the core, arranged on one or both sides of the core 440 the sides of the channels 452a . . . 452n thus form teeth 451a . . . 451n. The teeth 451a . . . 451n extend from the core 440, provide sidewalls for the channels 452a . . . 452n, and provide magnetic flux paths during operation. The channels 452a . . . 452n may be formed in the core 440 by slot cutting, such as through waterjet, abrasive cutting, milling, or electrical discharge machining, casting, or other processes. Optionally, a corresponding permanent magnet (not shown) may be placed on top of each tooth, or within each channel, secured to the structure by an epoxy or other bonding material.

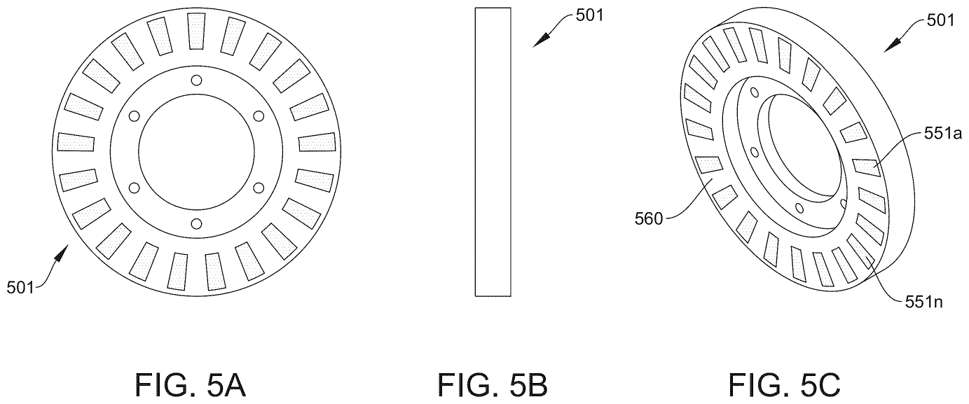

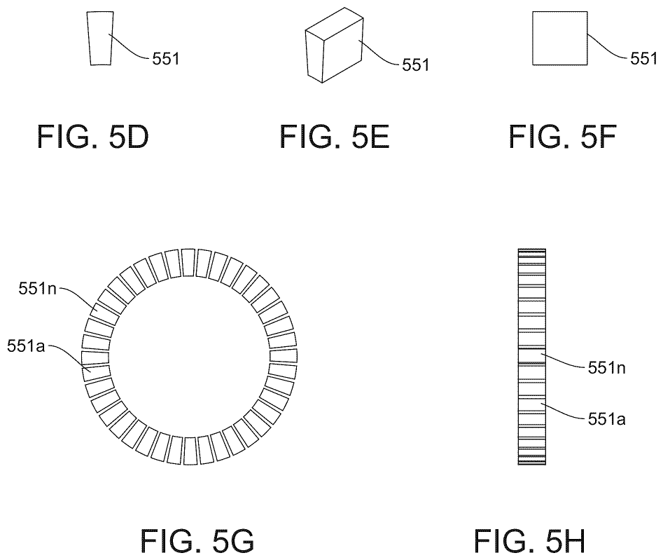

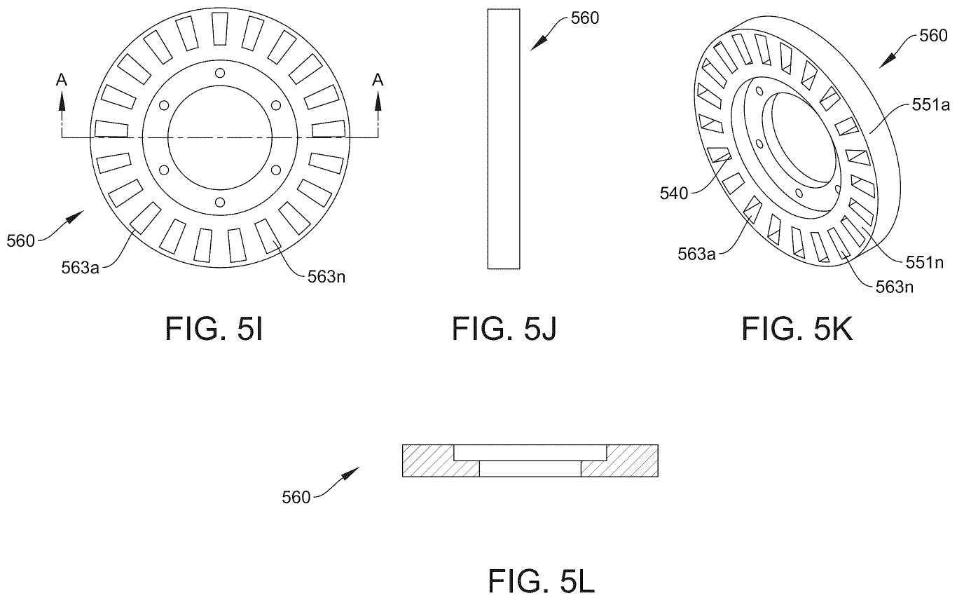

FIGS. 5A-5C respectively illustrate a top view, a side view and a perspective view of a fourth embodiment of a rotor 501. This embodiment also includes a set of any number of rotor wedge segments 551a . . . 551n (sometimes referred to individually as 551), examples of which are shown in the first side, perspective, and second side views of FIGS. 5D-5F. The rotor wedge segments 551a . . . 551n of this embodiment have size, material, and other properties corresponding to those discussed above in the first embodiment (FIG. 2). The rotor wedge segments 551a . . . 551n are arranged in a ring as shown in FIGS. 5G-5H. However, instead of being secured to a rotor back iron (i.e., a base) as in FIG. 2, in the embodiment of FIG. 5 the rotor wedge segments 551a . . . 551n are contained within openings of a carriage or housing 560. This embodiment can help reduce the overall thickness, mass and design complexity of the rotor as compared to axial flux motors that include a rotor back plate.

As illustrated in FIGS. 5A-C and 5I-L, in various embodiments the carriage 560 may be a solid or hollow, circular, disc-shaped housing with substantially equally spaced receptacles 563a . . . 563n arranged in the form of a ring or circle. Each receptacle 563 is sized and shaped to receive a corresponding rotor wedge segment 551. The rotor wedge segments 551a . . . 551n, sidewalls of the receptacles 563a . . . 563n, or both may be coated with an epoxy before the rotor wedge segments 551a . . . 551n are placed in the receptacles 563a . . . 563n to help securely bond each rotor wedge segment 551 to the sidewalls of its corresponding receptacle 563. Other bonding methods, such as those described above, may be used. The particular embodiment described here may provide benefits and advantages such as robust mechanical properties, low windage losses in operation, ease of balancing, and compatibility with high volume manufacturing and inventory processes. This embodiment is also compatible with employing a carbon or other fiber-based wrap for mechanical reinforcement.

The rotor wedge segments 551a . . . 551n will be formed of a magnetic material to provide magnetic flux paths. Example materials may include nanocrystalline alloys (e.g., FeNiNbBSi, FeSiBNbCu, and/or an iron-nickel-cobalt alloy such as CoFeSiBNb, CoFeMnSiBNb, FeCoSiBNb, or FeCoSiBNbCu), amorphous alloys, electrical steels (such as FeSi), iron cobalt alloys, soft magnetic composites, soft magnetic ferrites, and other such materials. The carriage 560 may be formed of a different one of the materials described above, or a different material entirely. For example, the carriage 560 may be made of aluminum and the rotor wedge segments 551a . . . 551n may be formed of a nickel alloy. The carriage 560 may be formed using casting, die cutting, additive manufacturing, or other methods. Optionally, permanent magnets could be attached to or positioned between the rotor wedge segments 551a . . . 551n.

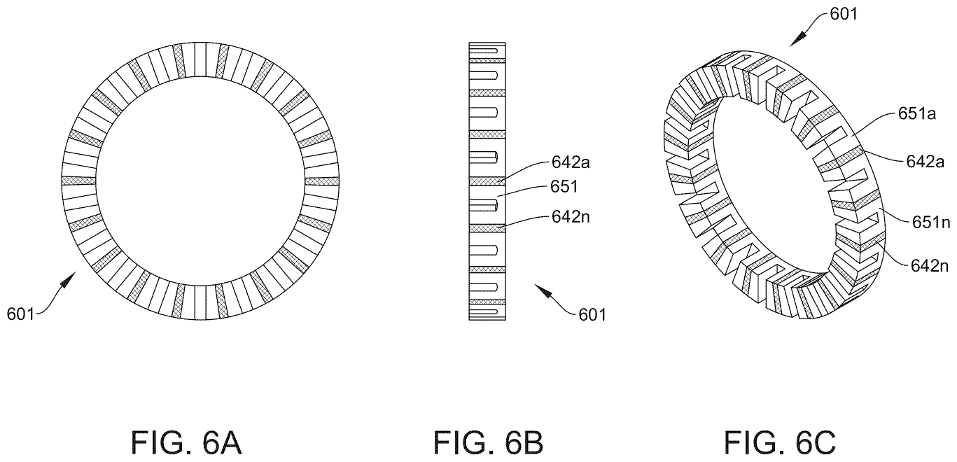

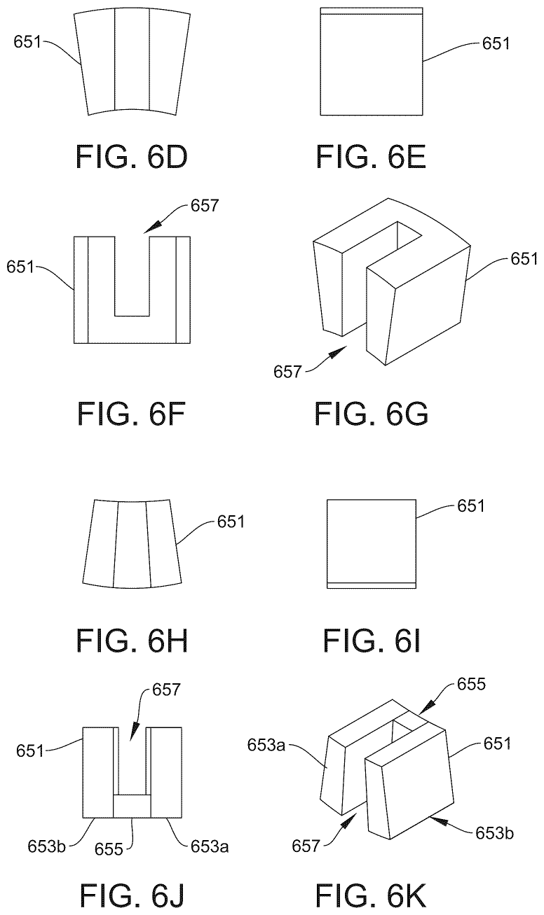

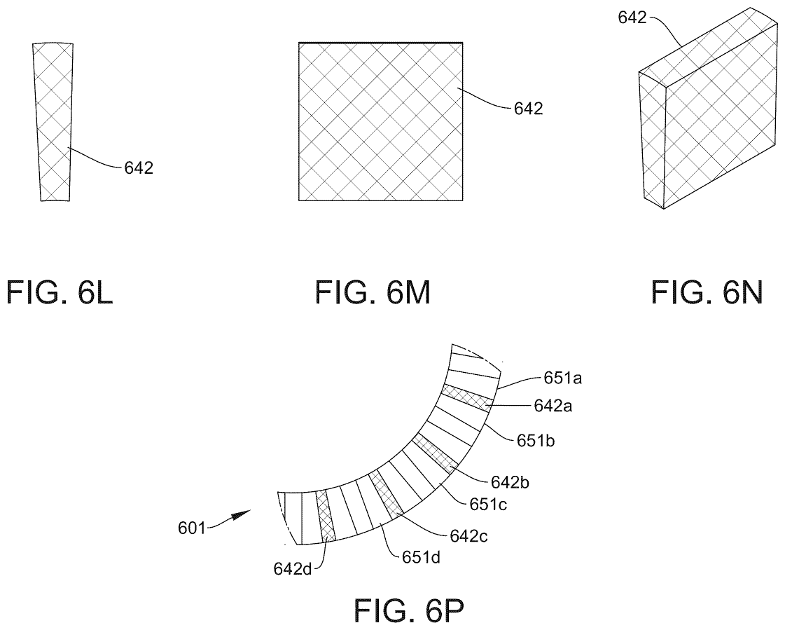

FIGS. 6A-6C respectively illustrate a top view, a side view, and a perspective view of a first embodiment of a stator 601. In FIG. 6 the stator includes various bridge segments 642a . . . 642n, each of which is attached to and thus interconnects and serves as a bridge between two stator wedge segments 651a . . . 651n (which may be individually referred to as 651). The stator wedge segments 651a . . . 651n and stator bridge segments 642a . . . 642n may be secured to each other with an epoxy or by another bonding method such as those described above.

FIGS. 6D-6F respectively illustrate a front view, a side view, a bottom view and a perspective view of a stator wedge segment 651 that may be included in this embodiment. Each stator wedge segment is a block with a channel 657, and thus exhibits a U-shape when viewed from the top or bottom (as in FIG. 6F). Each channel 657 may be formed in a stator wedge segment 651 by cutting, casting, or molding a monolithic block as shown in the stator wedge segment variation of FIGS. 6D-6G. Alternatively as shown in FIGS. 6H-6K, a variation of the stator wedge segment may include two teeth 653a, 653b, each of which is connected to a bar 655, so that the bar 655 interconnects the teeth 653a, 653b and the three pieces together form a U-shape with a central channel 657. In either variation, the stator wedge segments 651a . . . 651n may be tapered as shown, with a relatively larger top and a relatively smaller bottom. Alternatively, the stator wedge segments 651a . . . 651n may be straight cut if the stator bridge segments 642a . . . 642n are sufficiently tapered.

FIGS. 6L-6N respectively illustrate a first view, a second view and a perspective view of a stator bridge segment 642 that may be included in the second embodiment. The stator bridge segments may be formed in any of the shapes, materials, or other forms as are described above with respect to rotor bridge segments 340 in the discussion of FIG. 3. Each stator bridge segment 642 may be tapered as shown, with a relatively larger top and a relatively smaller bottom. Alternatively, the stator bridge segments 642a . . . 642n may be straight cut if the stator wedge segments 651a . . . 651n are sufficiently tapered.

As shown in FIGS. 6A-6C, when the stator 601 is assembled the channels of all of the wedge segments 651a . . . 651n are oriented along a common axis. For example, FIG. 6A shows all channels with their openings facing upward, while FIG. 6B shows all channels with their openings facing to the left.

FIG. 6P is an expanded view of a section of the stator 601 showing alternating wedge segments 651a . . . 651n and bridge segments 642a . . . 642n, secured to each other by epoxy or other materials. Each bridge segment 642 may be or include a permanent magnet. To produce a desired flux pattern, the polarity orientation of the magnets may alternate so that in the ring structure, the positive side of each bridge segment 642 faces the positive side of the next (or previous) bridge segment 642, and the negative side of each bridge segment 642 faces the negative side of the next (or previous) bridge segment 642. For example, in FIG. 6P, the positive side of bridge segments 642a and 624c face the clockwise direction around the ring, while the positive side of bridge segments 642b and 624d face the counterclockwise direction around the ring. Thus, the bridge segments are arranged in a ring so that the direction of polarity of each bridge segment is opposite that of the next and the previous bridge segment in the ring.

The wedge segments 651a . . . 651n and bridge segments 642a . . . 642n may be secured to each other with an epoxy or by another bonding method such as those described above. The stator assembly 601 may be secured mechanically, adhesively, or by other means to a housing plate for final motor assembly.

In various embodiments, the rotor and/or stator assembly may use epoxy or other non-metallic structural support that integrates soft magnetic wedges, that are optionally flat, and also protects relatively brittle magnetic materials used within the assembly. This may eliminate the need for the rotor backing plate, such as in the embodiment shown in FIG. 5. “Soft” magnetic materials are generally known to those of skill in the art as materials that are easily magnetized and demagnetized. For example, they may have intrinsic coercivity Hₑ of less than 1000 amps per meter. The epoxy material may be selected to provide desired mechanical, thermal, and electrical properties, such as strength, stiffness, thermal conductivity, and electrical insulation. Example epoxy materials that may be used include, without limitation, the SCOTCH-WELD® line of structural adhesives offered by 3M, including but not limited to the DP460 product within this product line, which are capable of bonding the load-bearing parts of a product with a minimum of 4,000 psi, or approximately 4,000 psi, overlap shear strength at 75° F.

The segmented axial flux motor of the present invention may be formed from various material types, including bulk crystalline and nanocrystalline materials, as well as rare earth containing and rare earth free designs with high power density. Examples alloys that may be used include FeCoV, FeSi and nanocrystalline FeNiNbBSi, FeSiBNbCu and/or iron-nickel-cobalt alloys. Rare earth free designs may use ferrite or permanent magnets comprising Alnico. The modular design and simplified manufacturing processes open up new possibilities for material selection and combinations, resulting in improved motor performance and versatility.

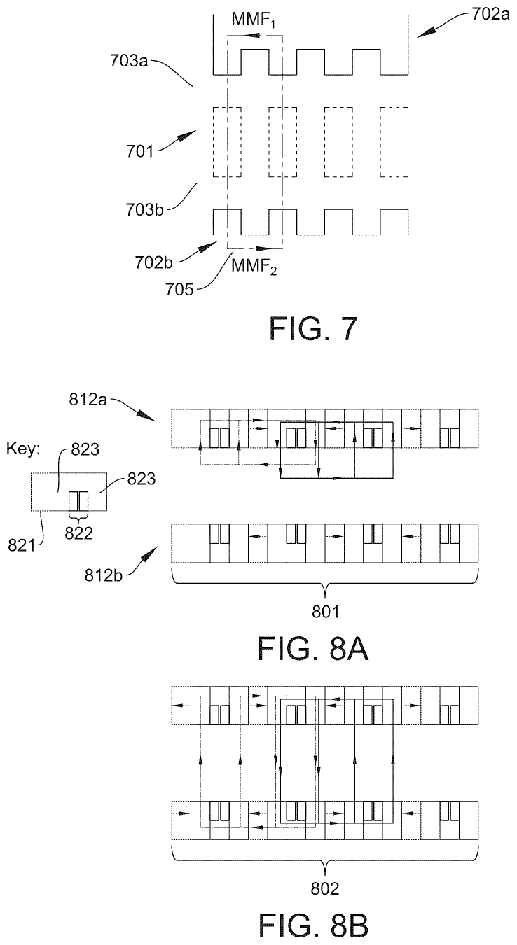

FIG. 7 illustrates how some of the present configurations (such as that of FIG. 5) may eliminate the back iron between the rotor tooth pieces 701, which may help lead to a significant reduction in the overall rotor thickness as compared to prior configurations. This alteration may contribute to lessening the mass of the motor, making it lighter and more efficient in operation than designs that include a back iron. Furthermore, without the need for back iron, the construction process of the motor can become considerably simplified, leading to a reduction in build complexity. In this embodiment, the axial force is not adversely affected by magnetomotive force 705 mismatch or a gap size 703a, 703b mismatch between the rotor 701 and the corresponding stators 702a, 702b. As a result, these modifications contribute not only to material conservation, but also to streamlined manufacturing and potentially lower production costs.

FIGS. 8A and 8B illustrate that in an axial flux motor with two stators 812a, 812b between which a rotor (not shown) is positioned, in prior motors example flux paths 801 are deflected by the rotor's back plate and return to the corresponding stator 812. In contrast, in present embodiments that do not include a rotor back plate (such as that of FIGS. 4, 5 and 7 of the present disclosure), flux paths 802 may flow through the rotor and each of the two stators 812a, 812b. This illustrates a way to make the motor's performance less susceptible to variations in mechanical tolerances such as gaps. This is achieved through the modification of the motor's flux paths, leading to an increase in robustness against mechanical discrepancies. In a dual-stator configuration, the magnetic field travels across the central rotor, a deviation from the traditional design where the field would typically return from rotor to stator. This change in flux path enables more efficient transfer of power and enhances the performance of the motor. In addition, the proposed rotor construction can be made thinner and lighter due to these modifications. The resulting design increases the motor's power density, providing more power per unit of weight, and potentially reduces production costs due to the simplified construction and use of fewer materials. The “key” in FIG. 8A identifies the element of the stator that are the permanent magnet 821, winding 822, and core 823.

The invention has been described with reference to various embodiments. However, it will be appreciated that modifications and variations can be made without departing from the scope of the invention as defined by the appended claims. The segmented axial flux motor described herein provides an innovative solution to simplify manufacturing processes, enable the use of various materials, and support high power density designs with both rare earth containing and rare earth free materials.

Without excluding further possible embodiments, certain example embodiments are summarized in the following clauses:

Clause 1: A segmented axial flux motor, comprising a rotor arranged in a first ring, and a stator arranged in a second ring. The stator is positioned proximate to the rotor. The rotor, the stator, or both are formed of a plurality of individual wedge segments.

Clause 2: The motor of clause 1, wherein the first ring of the rotor provides a base plate, and the individual wedge segments are arranged on at least one side of the first ring, substantially equally spaced apart from each other around the first ring.

Clause 3: The motor of clause 1 or 2, wherein the rotor comprises (a) the individual wedge segments, arranged to be substantially equally spaced apart from each other around the first ring, and (b) a plurality of bridge segments, each of which is secured to and interconnects a corresponding pair of the individual wedge segments. The individual wedge segments and the bridge segments are alternately positioned with respect to each other to form the first ring.

Clause 4: The motor of clause 1 or 2, wherein the rotor comprises (a) a circular disc-shaped carriage in which a plurality of receptacles are arranged in a circle and substantially equally spaced apart along the first ring, and (b) the individual wedge segments, each of which is positioned within a corresponding one of the receptacles.

Clause 5: The motor of clause 3 or 4, wherein the individual wedge segments are not connected to any rotor back iron.

Clause 6: The motor of any of clauses 1-5, wherein: (i) the stator comprises: (a) the individual wedge segments, arranged to be substantially equally spaced apart from each other around the first ring, and (b) a plurality of bridge segments, each of which is secured to and interconnects a corresponding pair of the individual wedge segments; (ii) each of the individual wedge segments is U-shaped and includes a channel, and; (iii) the channels of all of the individual wedge segments are oriented along a common axis.

Clause 7: The motor of clause 6, wherein the bridge segments are arranged around the second ring so that the direction of polarity each bridge segment is opposite that of the next bridge segment and the previous bridge segment in the second ring.

Clause 8: The motor of any of clauses 1-7, wherein the individual wedge segments are also arranged in a ring, and each of the individual wedge segments is tapered and positioned so that a relatively wider side of each wedge segment is positioned on an outer perimeter of the ring of wedge segments and a relatively narrower side of each wedge segment is positioned on an inner edge of the ring of wedge segments.

Clause 9: The motor of any of clauses 1-8, further comprising a plurality of permanent magnets, each of which is connected to a corresponding one of the wedge segments.

Clause 10: The motor of any of clauses 1-8, further comprising a plurality of permanent magnets, each of which is connected between a corresponding pair of the wedge segments.

Clause 11: The motor of any of clauses 1-10 wherein the rotor comprises one or more additional rings, and/or the stator comprises one or more additional rings.

Clause 12: A segmented axial flux motor, comprising: (a) a rotor assembly having a plurality of rotor segments; (b) a stator assembly having a plurality of stator segments; and (c) a structural bearing material mixed with magnetic materials within the rotor assembly or the stator assembly, wherein the rotor assembly and the stator assembly are configured in a modular design.

Clause 13: The segmented axial flux motor of clause 12, wherein the rotor assembly comprises a fully segmented rotor design and the stator assembly comprises a monolithic stator.

Clause 14: The segmented axial flux motor of clause 12 or 13, wherein the rotor assembly comprises a monolithic rotor and the stator assembly comprises a fully segmented stator design.

Clause 15: The segmented axial flux motor of any of clauses 12-14, further comprising an epoxy material providing structural support and creating a monolithic part with soft magnetic wedges that also protect brittle magnetic materials.

Clause 16: The segmented axial flux motor of any of clauses 12-15, wherein the stator assembly comprises one of the following: separate tooth pieces with bars to connect each tooth piece; a plurality of tooth pieces with a single backing plate; or a monolithic core cut to include teeth for the rotor.

Clause 17: The segmented axial flux motor of any of clauses 12-16, wherein the stator assembly comprises a single backing plate comprising a monolithic core with attached teeth.

Clause 18: The segmented axial flux motor of any of clauses 12-17, wherein the rotor assembly or the stator assembly comprises a plurality of tapered wedges, each of which is attached to or includes a permanent magnet or a flat soft magnet.

Clause 19: The segmented axial flux motor of clause 18, wherein each of the permanent magnets is configured with a straight cut to integrate into a core having a tapered cut.

Clause 20: The segmented axial flux motor of any of clauses 12-19, wherein the stator assembly and/or the rotor assembly comprise a mixture of or more of the following types of materials: bulk crystalline, amorphous, nanocrystalline, ferrite, and nitride.

Clause 21: The segmented axial flux motor of any of clauses 12-20, wherein the stator assembly, the rotor assembly or both comprise a soft magnetic material that comprises one or more of the following: FeNiNbBSi, FeSiBNbCu, or an iron-nickel-cobalt alloy.

Clause 22: The segmented axial flux motor of any of clauses 12-21, wherein the motor comprises rare earth containing materials and rare earth free materials.

Clause 23: A method of manufacturing a segmented axial flux motor, the method comprising: (a) fabricating a plurality of rotor segments; (b) fabricating a plurality of stator segments; and (c) assembling the rotor segments and stator segments to form a rotor assembly and a stator assembly, respectively, wherein (i) fabricating the rotor segments, fabricating the stator segments, or both comprises mixing a structural bearing material with magnetic materials for use within the rotor segments or the stator segments, and (ii) the rotor segments, the stator segments, or both comprise a plurality of material types.

Clause 24: The method of clause 23, wherein fabricating the segments further comprises shaping the segments by one or more of the following: waterjet; abrasive cutting; milling; or electrical discharge machining.

Clause 25: the method of clause 23 or 24, wherein the motor comprises a motor according to any of clauses 1-22.

1. A segmented axial flux motor, comprising:
a rotor arranged in a first ring; and
a stator arranged in a second ring, wherein the stator is positioned proximate to the rotor,
wherein the rotor, the stator, or both are formed of a plurality of individual wedge segments.

2. The motor of claim 1, wherein:
the first ring of the rotor provides a base plate; and
the individual wedge segments are arranged on at least one side of the first ring, substantially equally spaced apart from each other around the first ring.

3. The motor of claim 1, wherein the rotor comprises:
the individual wedge segments, arranged to be substantially equally spaced apart from each other around the first ring; and
a plurality of bridge segments, each of which is secured to and interconnects a corresponding pair of the individual wedge segments,
wherein the individual wedge segments and the bridge segments are alternately positioned with respect to each other to form the first ring.

4. The motor of claim 1, wherein the rotor comprises:
a circular, disc-shaped carriage in which a plurality of receptacles are arranged in a circle and substantially equally spaced apart along the first ring; and
the individual wedge segments, each of which is positioned within a corresponding one of the receptacles.

5. The motor of claim 4, wherein the individual wedge segments are not connected to any rotor back iron.

6. The motor of claim 1, wherein:
the stator comprises:
the individual wedge segments, arranged to be substantially equally spaced apart from each other around the first ring, and
a plurality of bridge segments, each of which is secured to and interconnects a corresponding pair of the individual wedge segments,
wherein:
each of the individual wedge segments is U-shaped and includes a channel, and
the channels of all of the individual wedge segments are oriented along a common axis.

7. The motor of claim 6, wherein the bridge segments are arranged around the second ring so that a direction of polarity of each bridge segment is opposite that of the next bridge segment and the previous bridge segment in the second ring.

8. The motor of claim 1, wherein:
the individual wedge segments are also arranged in a ring, and
each of the individual wedge segments is tapered and positioned so that a relatively wider side of each wedge segment is positioned on an outer perimeter of the ring of wedge segments and a relatively narrower side of each wedge segment is positioned on an inner edge of the ring of wedge segments.

9. The motor of claim 1, further comprising a plurality of permanent magnets, each of which is connected to a corresponding one of the wedge segments.

10. The motor of claim 1, further comprising a plurality of permanent magnets, each of which is connected between a corresponding pair of the wedge segments.

11. The motor of claim 1, wherein:
the rotor comprises one or more additional rings;
the stator comprises one or more additional rings; or
each of the rotor and the stator comprises one or more additional rings.

12. A segmented axial flux motor, comprising:
a rotor assembly having a plurality of rotor segments;
a stator assembly having a plurality of stator segments; and
a structural bearing material mixed with magnetic materials within the rotor assembly or the stator assembly,
wherein the rotor assembly and the stator assembly are configured in a modular design.

13. The segmented axial flux motor of claim 12, wherein the rotor assembly comprises a fully segmented rotor design and the stator assembly comprises a monolithic stator.

14. The segmented axial flux motor of claim 12, wherein the rotor assembly comprises a monolithic rotor and the stator assembly comprises a fully segmented stator design.

15. The segmented axial flux motor of claim 12, further comprising an epoxy material providing structural support and creating a monolithic part with soft magnetic wedges that also protect brittle magnetic materials.

16. The segmented axial flux motor of claim 12, wherein the stator assembly comprises one of the following:
separate tooth pieces with bars to connect each tooth piece;
a plurality of tooth pieces with a single backing plate; or
a monolithic core cut to include teeth for the rotor.

17. The segmented axial flux motor of claim 12, wherein the stator assembly comprises a single backing plate comprising a monolithic core with attached teeth.

18. The segmented axial flux motor of claim 12, wherein the rotor assembly or the stator assembly comprises a plurality of tapered wedges, each of which is attached to or includes a permanent magnet or a flat soft magnet.

19. The segmented axial flux motor of claim 18, wherein each of the permanent magnets is configured with a straight cut to integrate into a core having a tapered cut.

20. The segmented axial flux motor of claim 12, wherein the stator assembly and/or the rotor assembly comprise a mixture of or more of the following types of materials: bulk crystalline, amorphous, nanocrystalline, ferrite, and nitride.

21. The segmented axial flux motor of claim 12, wherein the stator assembly, the rotor assembly or both comprise a soft magnetic material that comprises one or more of the following: FeNiNbBSi, FeSiBNbCu, or an iron-nickel-cobalt alloy.

22. The segmented axial flux motor of claim 12, wherein the motor comprises rare earth containing materials and rare earth free materials.

23. A method of manufacturing a segmented axial flux motor, the method comprising:
fabricating a plurality of rotor segments;
fabricating a plurality of stator segments; and
assembling the rotor segments and stator segments to form a rotor assembly and a stator assembly, respectively,
wherein:
fabricating the rotor segments, fabricating the stator segments, or both comprises mixing a structural bearing material with magnetic materials for use within the rotor segments or the stator segments, and
the rotor segments, the stator segments, or both comprise a plurality of material types.

24. The method of claim 23, wherein fabricating the rotor segments, fabricating the stator segments, or both further comprises shaping the rotor segments, the stator segments, or both by one or more of the following:
waterjet;
abrasive cutting;
milling; or
electrical discharge machining.
